(19) United States
(12) Patent Application Publication
(10) Pub. No.: US 2003/0078792 A1
(43) Pub. Date: Apr. 24, 2003

(54) Commission free auction system and method therefor

(76) Inventor: Phillips A. Koss, Ft Hills, AZ (US)

Correspondence Address: WEISS & MOY PC, 4204 NORTH BROWN AVENUE, SCOTTSDALE, AZ, 85251, US

(21) Appl. No.: 10/037,112

(22) Filed: Oct. 22, 2001

(51) Int. Cl. G06F 17/60

(52) U.S. Cl. 705/1

(57) ABSTRACT

An auction system and method which only allows a user who has paid a membership fee to participate. A user accesses an auction website. The user logs into the auction website. However, only a user who has paid a membership fee is allowed to log into the auction website. The user locates an item he wishes to bid on and places a bid on the item. The auction of the item is stopped after a predetermined time frame. The funds of a participant who places a highest bid is verified and then charged.

### BACKGROUND OF THE INVENTION

1. Field of the Invention

This invention relates generally to auctions, and more specifically, to an auction system and method which will allow people to buy and sell items without the payment of a commission fee.

2. Background of the Invention

An auction is a public sale of property. In an auction, a seller will give an item to a person licensed and authorized to sell the product (hereinafter the auctioneer). The auctioneer will hold a public display of the item and will then hold the item up for sale on a predetermined day and/or days. On the day of the auction, buyers may place bids on the item. The buyer who places the highest bid on the item will then have the right to purchase the item at the bid price.

Auctions have become an extremely popular and successful way to buy and sell items. Buyers like the process since they may be able to purchase an item at a very reasonable price. In addition, many buyers like the fact that they can set a price at which they are willing to spend in order to purchase the item. If the auction price exceeds the price they are willing to pay, they may stop the bidding process. Many buyers like this since it gives them a feeling of being in control. Sellers like the auction 5 process because it gives them a marketplace in which to sell items. The auction process allows the seller to possibly sell an item far above the actual value of the item being sold.

There are several problems with current auction system. The first is that many auction systems are not readily available to the public. Many people are not aware of the local auction houses. Furthermore, many local auctions may be by invitation only thus shutting out a vast majority of the people in the surrounding area. Even if the auction is totally open to the public, it is generally limited to the number of individuals who can actually place bids on an item. However, the biggest problem with current auction systems is that the person holding the auction is always taking a percentage of the sales price. All auction houses take a commission on each item that is sold. Thus, the seller never gets what is actually paid for the sold item.

Therefore, a need existed to provide an improved auction system and method that overcomes the above problems. The improved auction system and method must be open to any and all potential buyers and sellers. The improved auction system and method must further be commission free for both the buyer and the seller. This will allow the seller to obtain the full purchase price of an item that he/she has placed up for auction and allowing the buyer to only pay the amount he/she has bid.

### SUMMARY OF THE INVENTION

In accordance with one embodiment of the present invention, it is an object of the present invention to provide an improved auction system and method.

It is another object of the present invention to provide an improved auction system and method that is open to any and all potential buyers and sellers.

It is still another object of the present invention to provide an improved auction system and method that is commission free.

It is still another object of the present invention to provide an improved auction system and method that is commission free for both the buyer and seller.

It is still another object of the present invention to provide an improved auction system and method that is commission free for both the buyer and seller thereby allowing the seller to obtain the full purchase price of an item that he/she has placed up for auction and allowing the buyer to only pay the amount he/she has bid.

### BRIEF DESCRIPTION OF THE PREFERRED EMBODIMENTS

In accordance with one embodiment of the present invention, a method for having a commission free auction is disclosed. The method comprises the steps of: assigning an item to be auctioned at a designated time; auctioning the item at the designated time wherein participants in the commission free auction have to pay a membership fee to participate; and verifying of funds from a participant who places the highest bid.

In accordance with another embodiment of the present invention, a method of participating in a commission free auction is disclosed. The method comprises the steps of: accessing an auction website; logging into the auction website wherein a user has to pay a membership fee to log into the auction website; locating an item to place a bid; placing a bid on the item; stopping bidding on the item after a predetermined time frame; and verifying funds of a participant who places a highest bid.

In accordance with another embodiment of the present invention, a commission free auction system is disclosed. The commission free auction system has a plurality of computers for accessing an auction website. An auction web server is provided for hosting the auction website. A database is coupled to the auction web server for allowing only users who have paid a membership fee to access the auction website.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiment when read in conjunction with the accompanying drawings, wherein like reference numerals and symbols represent like elements.

FIG. 1 is a simplified function block diagram of the commission free auction system of the present invention.

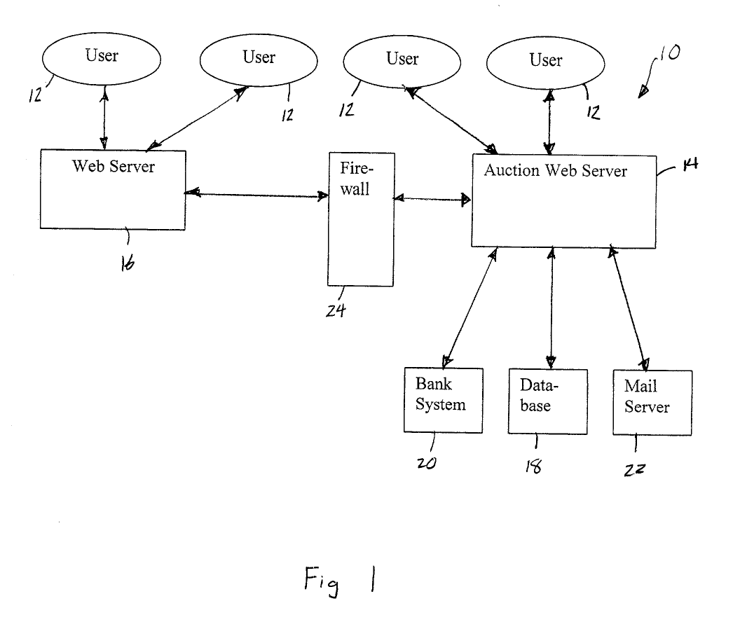

FIG. 2 is a flow chart showing a method for a commission free auction system

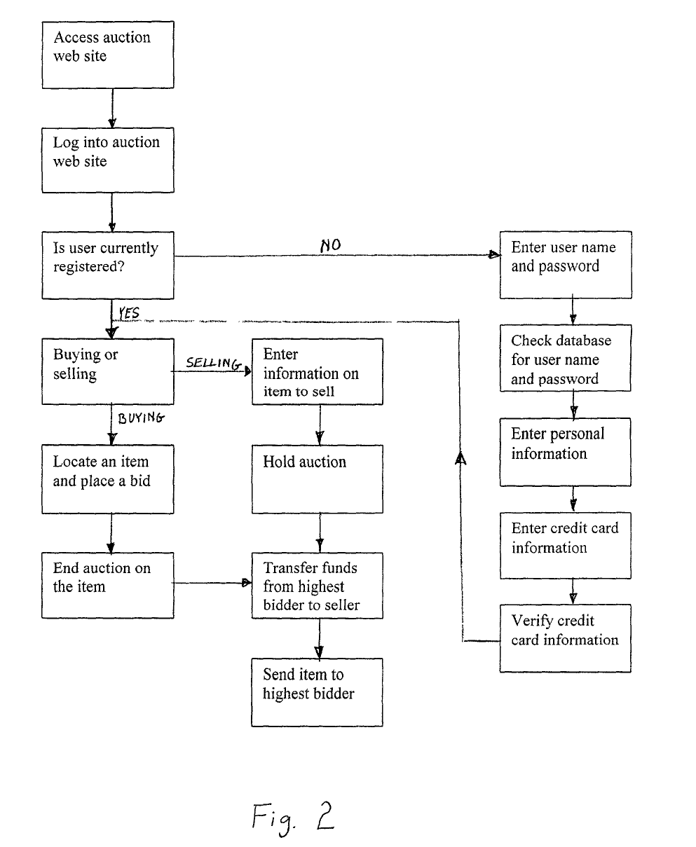

### DETAILED DESCRIPTION

Referring now to the Figures, a commission free auction system 10 (hereinafter system 10) and method are shown. The system 10 is a computer based auction system. The system 10 will allow a plurality of different users 12 to participate in the auction. The users 12 may be in any location around the world. The number of users 12 is only limited by the size of the auction web server 14.

Each user 12 will log on to the Internet by using a computer. The computer may be at home, an Internet cafe, a library, etc. Any computer may be used as long as the computer has Internet access. The user 12 may directly access the auction web server 14 or the user may access the auction web server 14 via another web server 16.

Once a user 12 accesses the auction web server 14, the user 12 will be asked to enter a user name and a password. If the user 12 does not have a user name and password, the user 12 may register for one.

When a person registers, the person will enter a user name and a password. The user name and password will be compared with all current registered users 12 stored in the database 18. If the user name and password are not being used, the new user name and password will be accepted and added to the database 18. The user 12 must then enter some further personal information such as the user's actual name, current address, phone number, email address, credit card information, etc.).

Once the credit card information is entered, the credit card information needs to be verified. The auction web server 14 will contact the corresponding bank system 20 to verify the credit card information. If the user 12 is authorized to use the credit card number entered, the user 12 will be registered with the auction web server. The credit card may then be used to make purchases and to charge membership dues which are paid to remain active in the system 10. Membership dues may be required, monthly, semi-annually, annually, etc. It should be noted that other payment methods may be used for the payment of membership fees and purchased items. For example, cash transfers, checks, money orders, and the like may be used. The listing of the above methods should not be seen as to limit the scope of the present invention.

The system 10 will have a mail server 22. The mail server 22 is coupled to the auction web server 14. The mail server will send out an email message to a user 12 when the user has either sold or purchased an item. The email server 22 is just used for notification purposes.

The system 10 may further have a firewall 24. The firewall 24 is used to protect the auction web server 14 from unauthorized access. The firewall 24 is used to prevent people from hacking into the auction web server 14 and gather personal information of the user 12.

### Operation

As stated above, a user 12 will gain access to the Internet and will access the auction website. The user 12 may directly access the auction web server 14 or the user may access the auction web server 14 via another web server 16.

Once a user 12 accesses the auction web server 14, the user 12 will be asked to enter a user name and a password. If the user 12 does not have a user name and password, the user 12 may register for one. When a person registers, the person will enter a user name and a password. The user name and password will be compared with all current registered users 12 stored in the database 18. If the user name and password are not being used, the new user name and password will be accepted and added to the database 18. The user 12 must then enter some further personal information such as the user's actual name, current address, phone number, email address, credit card information, etc.).

Once the credit card information is entered, the credit card information needs to be verified. The auction web server 14 will contact the corresponding bank system 20 to verify the credit card information. If the user 12 is authorized to use the credit card number entered, the user 12 will be registered with the auction web server. The credit card may then be used to make purchases and to charge membership dues which are paid to remain active in the system 10. Membership dues may be required, monthly, semi-annually, annually, etc.

Once a user 12 has entered a valid user name and password, the user 12 will gain access to the auction web site. The auction website will ask the user 12 whether the user wished to buy or sell an item. If the user 12 wishes to buy an item, the user 12 will be transferred to a buy web page. The buy web page will have a listing of the different categories of items that are for sale. The user may then select a category and be transferred to another webpage which will display different items in the selected category. Each item displayed will have a link which will show further information related to the item. For example, some of the information that may be displayed includes, but is not limited to, a written description of the item, notice of when the auction will begin and end, a minimum bid price, current bid price, bid increment, and other similar information.

If the user 12 wishes to place a bid, the user 12 will select a link which will allow the user 12 to enter a bid price. When the bid link is selected, the user 12 will then enter and submit a dollar bid amount. The user 12 may continuously update to increase his/her bid amount. However, once a bid is entered, it cannot be retracted.

When the auction of an item has ended, the highest bid price will be declared the winner. The funds of the user 12 who is places the highest bid will be verified. If the user 12 has a sufficient amount of funds, the user's credit card may be charged for the purchase. It should be noted that alternative payment methods may be used besides credit card payment (i.e., cash transfers, checks, money orders, etc.). An email will then be sent out to the winner notifying the user 12 that he/she has won. The item will then be sent to the winning user 12.

If a user 12 wishes to sell an item, the user will be sent to a sell webpage. The user will then enter information regarding the product to sell. For example, the user will enter a file with a photo of the item, a brief description of the item, a minimum bid price, bid increments, start and end of the auction, and similar information. The user 12 will further add contact information should a buyer have any questions regarding the item for sale. The user 12 must then enter this information into the system 10. Once the auction is completed, the seller must then ship the item to the user 12 having the highest bid.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for having a commission free auction comprising the steps of:
assigning an item to be auctioned at a designated time;
auctioning the item at the designated time wherein participants in the commission free auction have to pay a membership fee to participate; and
verifying of funds from a participant who places the highest bid.

2. The method of claim 1 further comprising the step of charging a credit card of the participant who places the highest bid.

3. The method of claim 2 further comprising the step of sending the item to the participant who places the highest bid.

4. A method of participating in a commission free auction comprising the steps of:
accessing an auction website;
logging into the auction website wherein a user has to pay a membership fee to log into the auction website;
locating an item to place a bid;
placing a bid on the item;
stopping bidding on the item after a predetermined time frame; and
verifying funds of a participant who places a highest bid.

5. The method of claim 4 further comprising the step of charging a credit card of the participant who places the highest bid.

6. The method of claim 5 further comprising the step of sending the item to the participant who places the highest bid.

7. The method of claim 4 wherein the steps of logging into the website further comprises the steps of—
entering a user name and a user password;
verifying the user name and the user password; and
granting access if user name and user password are verified.

8. A commission free auction system comprising, in combination:
a plurality of computers for accessing an auction website;
an auction web server for hosting the auction website; and
a database coupled to the auction web server for allowing only users who have paid a membership fee to access the auction website.

9. A commission free auction system in accordance with claim 8 further comprising a mail server coupled to the auction web server for sending out emails to a user who has at least one of purchased or sold an item on the auction web site.

10. A commission free auction system in accordance with claim 9 further comprising a banking system coupled to the auction web server for verifying and charging funds of a user of the commission free auction system.

11. A commission free auction system in accordance with claim 10 further comprising a firewall coupled to the auction web server for preventing unauthorized access to the auction web server.
